(19) United States
(12) Patent Application Publication
(10) Pub. No.: US 2024/0250464 A1
(43) Pub. Date: Jul. 25, 2024

(54) CONNECTOR

(71) Applicant: SUMITOMO WIRING SYSTEMS, LTD., Mie (JP)

(72) Inventors: Ayaka NITO, Mie (JP); Motohiro ANDO, Mie (JP)

(21) Appl. No.: 18/405,145

(22) Filed: Jan. 5, 2024

(30) Foreign Application Priority Data
Jan. 20, 2023 (JP) 2023-007237

(51) Int. Cl. H01R 13/24; H01R 13/405; H01R 13/50

(52) U.S. Cl. CPC H01R 13/2478; H01R 13/405; H01R 13/50; H01R 13/2492

(57) ABSTRACT

A connector 1 is provided with a connector body 3 in which a busbar 10 to be electrically connected to a mating terminal 13 is integrally formed with resin by molding. The busbar 10 includes a convex contact point portion 24 formed by convexly bending a part of the busbar 10 as a contact point with the mating terminal 13, and an engaging portion 27 formed on an inner surface of the convex contact point portion 24 in such a manner as to be embedded in a body 11 of the connector body 3.

### CROSS-REFERENCE TO RELATED APPLICATIONS

This application is based on and claims priority from Japanese Patent Application No. 2023-007237, filed on Jan. 20, 2023, with the Japan Patent Office, the disclosure of which is incorporated herein in its entirety by reference.

### TECHNICAL FIELD

The present disclosure relates to a connector.

### BACKGROUND

Conventionally, an insert-molded article formed by insert-molding a terminal with resin is known as disclosed in Japanese Patent Laid-open Publication No. 2000-251997. The terminal includes a connecting plate portion for connecting a bonding wire. The connecting plate portion is formed with a plurality of resin filling holes in a welding surface for welding the bonding wire. Gap resin portions are formed in the resin filling holes by the filled resin. The resin filling holes are formed into an inverted truncated conical shape.

### SUMMARY

In the case of Japanese Patent Laid-open Publication No. 2000-251997, since the peripheral edges of the resin filling holes are engaged with the gap resin portions after insert molding, the connecting plate portion can be made difficult to lift. However, since the resin filling holes are formed in the connecting plate portion, there is a concern that the resin creeps up to the welding surface during insert molding. If this occurs, there has been a possibility that a contact failure and the like occur since the resin is present on the welding surface of the connecting plate portion.

The present disclosure aims to provide a connector capable of making a busbar difficult to lift and making a contact failure difficult to occur in the busbar.

The present disclosure is directed to a connector with a connector body, a busbar to be electrically connected to a mating terminal being integrally formed with resin by molding in the connector body, the busbar including a convex contact point portion formed by convexly bending a part of the busbar as a contact point with the mating terminal, and an engaging portion formed on an inner surface of the convex contact point portion in such a manner as to be embedded in a body of the connector body.

According to the present disclosure, a busbar can be made difficult to lift and a contact failure can be made difficult to occur in the busbar.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector.

FIG. 2 is a section along II-II shown in FIGS. 1 and 3.

FIG. 3 is an enlarged perspective view of a connector body.

FIG. 4 is a perspective view of the connector.

FIG. 5 is a partial enlarged perspective view of a busbar.

FIGS. 6A to 6C are diagrams of a formation procedure of convex contact point portions and engaging portions.

FIG. 7 is a section of a conventional positioning busbar.

FIG. 8 is an action diagram of the engaging portion.

FIG. 9 is a partial enlarged perspective view of a busbar of another example.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

First, embodiments of the present disclosure are listed and described.

[1] The connector of the present disclosure is provided with a connector body, a busbar to be electrically connected to a mating terminal being integrally formed with resin by molding in the connector body, the busbar including a convex contact point portion formed by convexly bending a part of the busbar as a contact point with the mating terminal, and an engaging portion formed on an inner surface of the convex contact point portion in such a manner as to be embedded in a body of the connector body.

According to this configuration, the busbar can be firmly fixed to the body by a structure for embedding the engaging portion on the inner surface of the convex contact point portion in a raised portion of the body accommodated into the convex contact point portion. In this way, the busbar can be made difficult to lift from the body. Further, if a measure to prevent the lift of the busbar is taken by providing the busbar with the engaging portion and embedding the engaging portion in the body, the busbar needs not be formed with any hole. Thus, the resin does not creep up to the upper surface of the busbar during insert molding. Therefore, a contact failure can be made difficult to occur in the busbar.

[2] In [1] described above, the engaging portion is formed on the busbar simultaneously with the convex contact point portion when the convex contact point portion is formed on the busbar. According to this configuration, the convex contact point portion and the engaging portion can be simultaneously formed when the busbar is worked to form the convex contact point portion. Thus, the manufacturing of the busbar can be simplified.

[3] In [1] or [2] described above, the convex contact point portion includes a recess formed by thinning a part of the busbar on the inner surface, and the engaging portion is formed on at least a part of a peripheral edge of the recess. According to this configuration, in forming the convex contact point portion and the engaging portion on the busbar, it is sufficient to merely form the recess in the underside of the busbar and bend a part of the busbar including the recess. Therefore, the manufacturing of the busbar can be said to be simple in this respect.

[4] In [3] described above, the recess is formed into a shape having an opening in the form of a long hole, the recess is provided with a pair of width direction opening edges extending in a width direction of the busbar and arranged to face each other and a pair of width cross direction opening edges extending in a direction intersecting the width direction opening edges and arranged to face each other, and the engaging portions are formed at least on the width direction opening edges. According to this configuration, the shape of the recess can be a simple shape having an opening in the form of a long hole. Further, since being arranged to face each other, a pair of the engaging portions can have an embedded shape sandwiching the body from both sides. Therefore, the engaging portions can be firmly embedded in the body.

[5] In any one of [1] to [4] described above, a plurality of sets each including the convex contact point portion and the engaging portion are provided on the busbar. According to this configuration, the busbar can be fixed to the body by the plurality of engaging portions, which further contributes to preventing the lift of the busbar.

[6] In any one of [1] to [5] described above, the convex contact point portion is arranged at a position near a tip of the busbar. According to this configuration, the lift of the busbar from the tip can be made difficult to occur, which further contributes to preventing the lift of the busbar.

[7] In any one of [1] to [6] described above, the busbar includes a busbar body portion at least partially embedded in the body and a busbar tip portion exposed from the body and shaped by being bent in a direction intersecting an extending direction of the busbar body portion, and the convex contact point portion and the engaging portion are provided on the busbar tip portion. According to this configuration, the busbar tip portion can be made difficult to lift from the body.

[8] In [7] described above, the body includes a seat portion for placing the busbar tip portion, and the busbar tip portion is formed to have the same width and depth as the seat portion in a part to be placed on the seat portion. According to this configuration, if the busbar tip portion is shaped to be placed on the seat portion of the body, there is, for example, a possible situation where the busbar tip portion can only be formed to have the same area as the seat portion. However, since the busbar tip portion is provided with the engaging portion, the busbar tip portion can be firmly fixed to the seat portion even if the busbar tip portion is limited in size.

[9] In [7] described above, the busbar tip portion is in the form of a rectangular plate, and the convex contact point portions are arranged side by side in a longitudinal direction of the busbar tip portion in the case of providing a plurality of the convex contact point portions. According to this configuration, the convex contact point portions can be arranged in a well-balanced manner at suitable positions on the busbar tip portion in the form of a rectangular plate.

[10] In any one of [1] to [9] described above, the mating terminal includes a plate-like portion for contacting the busbar. According to this configuration, even if the plate-like portion of the mating terminal is brought into contact with the busbar, the plate-like portion and the busbar can easily contact each other since a contact destination of the plate-like portion is the convex contact point portion.

[11] In any one of [1] to [10] described above, the busbars are arranged side by side in a plane direction of the connector body in the case of providing a plurality of the busbars. According to this configuration, the shape of the connector body can be such a simple shape that the busbars are juxtaposed in the plane direction of the connector body.

### DETAILS OF EMBODIMENT OF PRESENT DISCLOSURE

A specific example of the present disclosure is described below with reference to the drawings. Note that the present invention is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different from an actual one in each figure.

### (Connector 1)

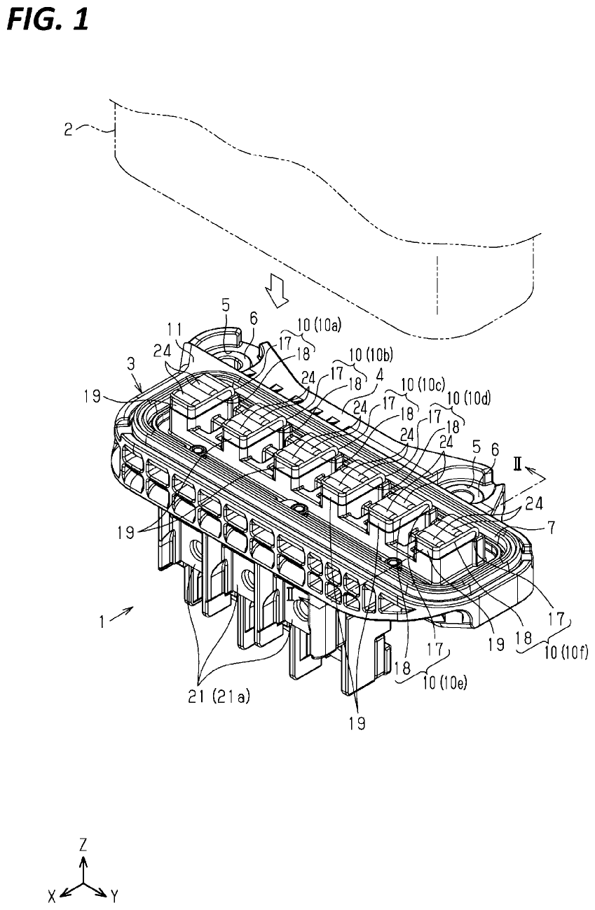

As shown in FIG. 1, a connector 1 is provided with a connector body 3 to be electrically connected to a mating connector 2. In the case of this example, for example, the connector 1 is a male connector and the mating connector 2 is a female connector. The connector 1 is mounted on a mounting destination (not shown) by fixing fasteners (not shown) to the mounting destination while inserting the fasteners in collars 6 inserted in holes 5 of a mounting piece 4. A sealing member 7 for sealing a gap between the mating connector 2 and the connector 1 is mounted on the connector 1. The connector 1 is, for example, preferably for vehicle.

### (Connector Body 3)

As shown in FIG. 1, the connector body 3 is provided with a plurality of (six in this example) busbars 10. The connector body 3 is a resin molded article in which the busbars 10 are integrally molded with resin by molding. In the case of this example, the connector body 3 is integrally formed with the resin, for example, by molding to set the plurality of busbars 10 in a mold and pouring the resin. In the case of this example, the connector body 3 includes the plurality of busbars 10 and a body 11 made of resin and integrated with these busbars 10. The mounting piece 4 is formed on the body 11.

### (Mating Terminals 13)

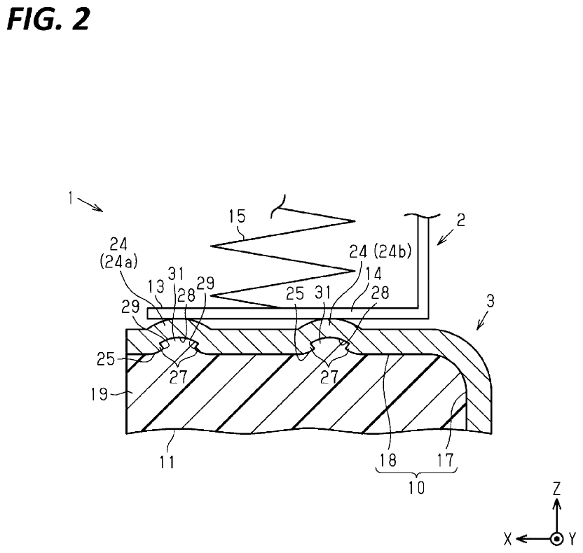

As shown in FIG. 2, the mating connector 2 is provided with a plurality of (only one is shown in FIG. 2) mating terminals 13 to be electrically connected to the respective busbars 10. The mating terminal 13 includes a plate-like portion 14 for contacting the busbar 10. The mating terminal 13 is biased toward the busbar 10, for example, by a biasing portion 15 such as a spring. Thus, the mating terminal 13 is pressed against the busbar 10 with a predetermined contact pressure by a biasing force of the biasing portion 15.

### (Busbars 10)

As shown in FIG. 1, the plurality of busbars 10 are arranged side by side in a plane direction (X-Y plane direction of FIG. 1) of the connector body 3. In the case of this example, the six busbars 10 provided are successively referred to as a first busbar 10a, a second busbar 10b, a third busbar 10c, a fourth busbar 10d, a fifth busbar 10e and a six busbar 10f from left in the plane of FIG. 1.

As shown in FIG. 2, the busbar 10 includes a busbar body portion 17 at least partially embedded in the body 11 and a busbar tip portion 18 exposed from the body 11 and shaped by being bent in a direction (X-axis direction of FIG. 2) intersecting an extending direction (Z-axis direction of FIG. 2) of the busbar body portion 17. In the case of this example, the busbar body portion 17 and the busbar tip portion 18 are bent perpendicular to each other.

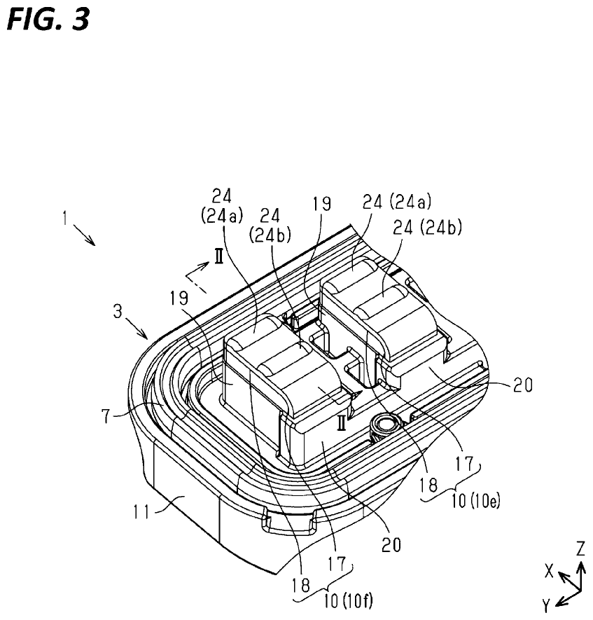

As shown in FIG. 3, the busbar tip portion 18 is, for example, in the form of a rectangular plate. The body 11 includes seat portions 19 for placing the busbar tip portions 18. The busbar tip portion 18 is formed to have the same width and depth as the seat portion 19 in a part to be placed on the seat portion 19. Note that a dimension in a width direction is a dimension in a Y-axis direction shown in FIG. 3. Further, a dimension in a depth direction is a dimension in the X-axis direction shown in FIG. 3.

The connector body 3 includes supporting portions 20 for supporting the busbars 10 by a thickness of the body 11. For example, the supporting portion 20 supports the busbar body portion 17 by sandwiching the busbar body portion 17 from both sides by the resin material of the body 11.

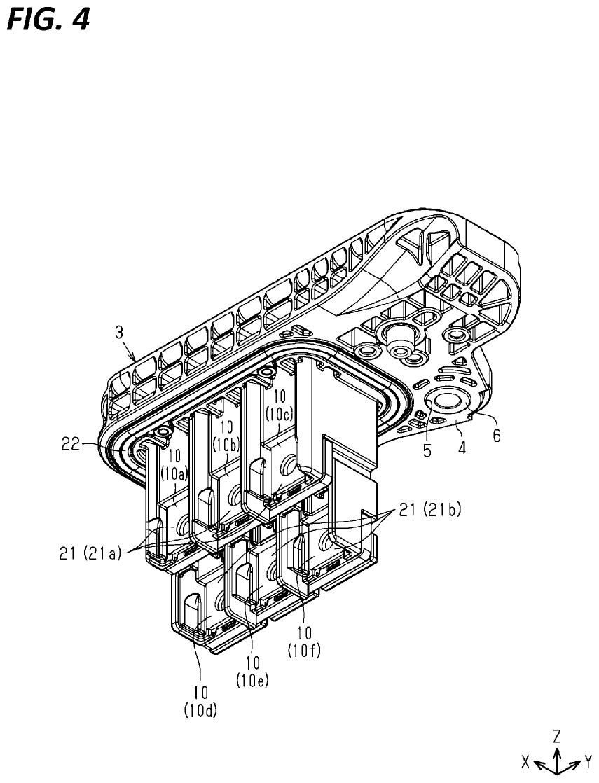

As shown in FIG. 4, base ends 21 of the respective busbars 10 are so arranged that a group of base ends 21a of the first, second and third busbars 10a, 10b and 10c and a group of base ends 21b of the fourth, fifth and sixth busbars 10d, 10e and 10f are respectively aligned in the width direction (Y-axis direction of FIG. 4) of the connector body 3. Note that, in the respective busbars 10, the busbar body portions 17 are so shaped that the base ends 21a, 21b can be aligned as described above. Note that a sealing member 22 for sealing a gap between the connector 1 and a mounting destination (not shown) is mounted on the connector body 3.

### (Convex Contact Point Portions 24)

As shown in FIGS. 2 and 3, the busbar 10 is provided with convex contact point portions 24 formed by convexly bending parts of the busbar 10 as contact points with the mating terminal 13. In the case of this example, the convex contact point portions 24 are provided on the busbar tip portion 18. The convex contact point portion 24 is, for example, formed into a shape elongated in a width direction (Y-axis direction of FIG. 2) of the busbar 10 in a plan view.

A plurality of (two in this example) of the convex contact point portions 24 are, for example, provided on the busbar 10. In the case of two convex contact point portions 24, one is referred to as a first convex contact point portion 24a and the other is referred to as a second convex contact point portion 24b. In the case of providing a plurality of the convex contact point portions 24, the convex contact point portions 24 are arranged side by side in a longitudinal direction (X-axis direction of FIG. 2) of the busbar tip portion 18. The convex contact point portions 24 are, for example, preferably arranged at positions near the tip of the busbar 10. Specifically, out of the first and second convex contact point portions 24a, 24b, the first convex contact point portion 24a is arranged at a position near the tip of the busbar tip portion 18.

As shown in FIG. 2, the convex contact point portion 24 is, for example, formed into a semicircular shape in a cross-sectional view. In this way, the busbar tip portion 18 includes recessed portions 25 formed by providing the convex contact point portions 24 in the inner surface of the busbar 10. The recessed portion 25 is, for example, a recessed part formed by bending the convex contact point portion 24. Press-working as one type of bending is, for example, cited as a forming method of the convex contact point portions 24.

### (Lift Preventing Structure of Convex Contact Point Portions 24)

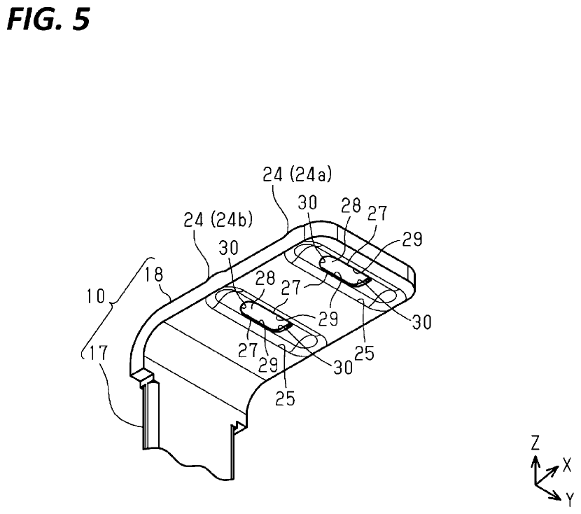

As shown in FIGS. 2 and 5, the busbar 10 includes engaging portions 27 formed on the inner surfaces of the convex contact point portions 24 in such a manner as to be embedded in the body 11 of the connector body 3. The engaging portion 27 is, for example, an undercut part projecting in a direction intersecting a mold opening/closing direction. The engaging portions 27 are, for example, formed on the busbar 10 simultaneously with the convex contact point portions 24 when the convex contact point portions 24 are formed on the busbar 10. A plurality of (two in this example) sets each including the convex contact point portion 24 and the engaging portions 27 are provided on the busbar 10. In the case of this example, the engaging portions 27 are provided on the busbar tip portion 18.

The engaging portion 27 is, for example, provided on a recess 28 formed in the inner surface of the convex contact point portion 24. The recess 28 is, for example, formed by thinning a part of the busbar 10. The recess 28 is, for example, arranged substantially in a center of the recessed portion 25 provided on the underside of the convex contact point portion 24.

As shown in FIG. 5, the recess 28 is formed into a shape having an opening in the form of a long opening. In this case, the recess 28 is provided with a pair of width direction opening edges 29 extending in the width direction of the busbar 10 and arranged to face each other. Further, the recess 28 is provided with a pair of width cross direction opening edges 30 extending in a direction (orthogonal direction in this example) intersecting the width direction opening edges 29 and arranged to face each other. The engaging portions 27 are formed at least on parts of the peripheral edge of the recess 28. As an example, the engaging portions 27 are preferably formed at least on the width direction opening edges 29, out of the peripheral edge of the recess 28. Note that the engaging portions 27 of this example are formed only on the width direction opening edges 29, out of the peripheral edge of the recess 28.

As shown in FIG. 2, the body 11 includes raised portions 31 made of resin and to be fit into the convex contact point portions 24 and engaged with the engaging portions 27. The raised portions 31 mean, for example, parts to be fit into both the recessed portions 25 and the recesses 28 in the inner surfaces of the convex contact point portions 24 and engaged with the engaging portions 27 formed on the opening edge parts of the recesses 28. In this way, the body 11 is fixed to the busbar 10 by being engaged with the engaging portions 27 of the convex contact point portions 24 at the raised portions 31.

Next, functions of the connector 1 of this embodiment are described.

### (Forming Method of Engaging Portions 27)

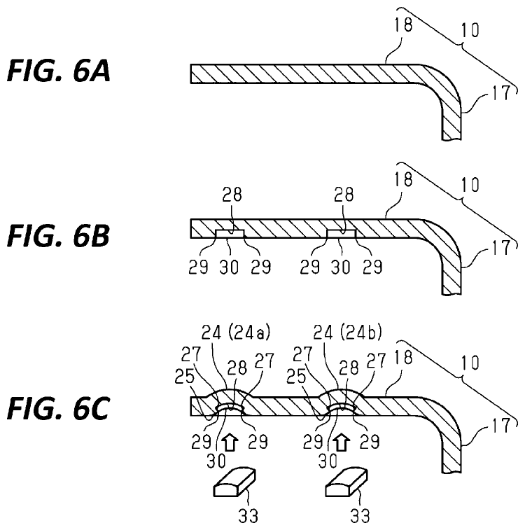

As shown in FIG. 6A, the busbar 10 including the busbar tip portion 18 bent in a direction substantially orthogonal to the busbar body portion 17 is prepared. Subsequently, as shown in FIG. 6B, the recesses 28 are formed in the underside of the busbar tip portion 18. A forming method of the recesses 28 is, for example, preferably cutting. In the case of this example, the recesses 28 are formed at two positions in the underside of the busbar tip portion 18.

As shown in FIG. 6C, after the recesses 28 are formed, the convex contact point portions 24 are formed by press-working the busbar tip portion 18 at the formation positions of the recesses 28. Press-working is preferably a working method for bending the busbar 10 by pressing dies 33 corresponding to the shape of the convex contact point portions 24 desired to be formed against the recesses 28 with a predetermined pressure from the underside of the busbar 10. The die 33 is, for example, preferably a die having an arcuate surface in cross-section, specifically a die half-moon shaped in cross-section and having left and right sides somewhat steeply descending.

In the case of this example, when the convex contact point portions 24 are formed by bending the busbar 10 using the dies 33, the engaging portions 27 are formed on the openings of the recesses 28 by the bending deformation of the busbar 10. In this way, the engaging portions 27 are simultaneously formed by press-working for forming the convex contact point portions 24. In the above way, a plurality of the busbars 10 including the engaging portions 28 on the inner surfaces of the convex contact point portions 24 are formed. By insert-molding these busbars 10, the connector body 3 in which the plurality of busbars 10 are integrated with the resin is manufactured.

### (Lift of Convex Contact Point Portions 24)

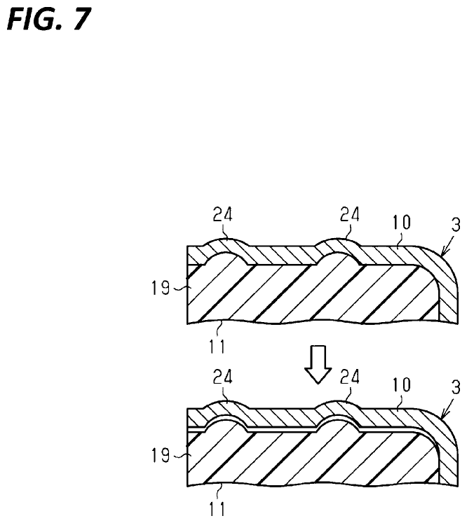

FIG. 7 shows the connector body 3 in which the busbars 10 are not formed with the engaging portions 27. After insert molding, the body 11 shrinks by cooling. Specifically, if the resin is cooled after insert molding, the body 11 shrinks in a direction separating from the busbars 10. Thus, gaps are formed between the busbars 10 and the body 11. If this occurs, a contact state of the busbars 10 and the mating terminals 13 is not stable and energization reliability is affected when the mating connector 2 is attached to the connector 1.

(Case where Busbars 10 are Provided with Engaging Portions 27)

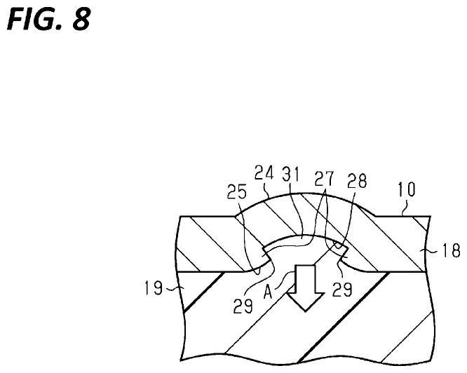

As shown in FIG. 8, if the engaging portions 27 are provided on the undersides of the busbars 10, it is possible to adopt such a structure that the engaging portions 27 are embedded in the body 11 when the connector body 3 is manufactured by insert molding. Thus, even if the body 11 shrinks in a direction of an arrow A in FIG. 8 by cooling after insert molding, the busbars 10 hardly lift since the engaging portions 27 are embedded in the body 11. Therefore, the connector 1 and the mating connector 2 can be attached in a stable contact state.

In embedding a part of the busbar 10 in the body 11, a structure for forming a hole in the busbar 10 and embedding the peripheral edge of the hole in the body 11 is, for example, also supposed. However, in the case of this structure, since the busbar 10 is formed with the hole, there is a concern that the resin creeps up to the upper surface of the busbar 10 during insert molding. If this occurs, there is a possibility of a contact failure. On the other hand, in the case of this example, the busbar 10 can be partially embedded in the body 11 even without providing any hole in the busbar 10. Therefore, it is not necessary to consider a risk of resin leakage and, consequently, a risk of a contact failure.

Further, for example, in embedding the parts of the busbar 10 in the body 11, a structure for embedding a bent part in the body 11 by bending an end part of the busbar 10 by a predetermined amount is, for example, also supposed. However, in the case of this structure, the part of the busbar 10 has to be used as the bent part to be embedded in the body 11. If an attempt is made to ensure an area of an electrical contact point of the busbar 10, the busbar 10 needs to have a large size. Thus, the use amount of the material of the busbar 10 is increased, which is disadvantageous in terms of cost. On the other hand, in the case of this example, since parts of the underside of the busbar 10 are embedded in the body 11, the use amount of the material of the busbars 10 is not increased.

### Effects of Embodiment

According to the above embodiment, the following effects can be achieved.

(1) The connector 1 is provided with the connector body 3 in which the busbars 10 to be electrically connected to the mating terminals 13 are integrally formed with the resin by molding. The busbar 10 includes the convex contact point portions 24 formed by convexly bending parts of the busbars 10 as contact points with the mating terminals 13, and the engaging portions 27 formed on the inner surfaces of the convex contact point portions 24 in such a manner as to be embedded in the body 11 of the connector body 3.

According to this configuration, the busbar 10 can be firmly fixed to the body 11 by the structure for embedding the engaging portions 27 on the inner surfaces of the convex contact point portions 24 in the raised portions 31 of the body 11 accommodated into the convex contact point portions 24. In this way, the busbar 10 can be made difficult to lift from the body 11. Further, if a measure to prevent the lift of the busbar 10 is taken by providing the busbar 10 with the engaging portions 27 and embedding the engaging portions 27 in the body 11, the busbar 10 needs not be formed with any hole. Thus, the resin does not creep up to the upper surface of the busbar 10 during insert molding. Therefore, a contact failure can also be made difficult to occur in the busbar 10.

(2) The engaging portions 27 are formed on the busbar 10 simultaneously with the convex contact point portions 24 when the convex contact point portions 24 are formed on the busbar 10. According to this configuration, the convex contact point portions 24 and the engaging portions 27 can be simultaneously formed when the busbar 10 is worked to form the convex contact point portions 24. Therefore, the manufacturing of the busbar 10 can be simplified.

(3) The convex contact point portion 24 includes, in the inner surface, the recess 28 formed by thinning a part of the busbar 10. The engaging portions 27 are formed at least on parts of the peripheral edge of the recess 28. According to this configuration, in forming the convex contact point portions 24 and the engaging portions 27 on the busbar 10, it is sufficient to merely form the recesses 28 in the underside of the busbar 10 and bend parts of the busbar 10 including the recesses 28. Therefore, the manufacturing of the busbar 10 can be said to be simple in this respect.

(4) The recess 28 is formed into a shape having an opening in the form of a long hole. The recess 28 is provided with the pair of width direction opening edges 29 extending in the width direction of the busbar 10 and arranged to face each other and the pair of the width cross direction opening edges 30 extending in the direction intersecting the width direction opening edges 29 and arranged to face each other. The engaging portions 27 are formed at least on the width direction opening edges 29. According to this configuration, the shape of the recess 28 can be a simple shape having an opening in the form of a long hole. Further, since being arranged to face each other, the pair of engaging portions 27 can have an embedded shape sandwiching the body 11 from both sides. Therefore, it is also possible to firmly embed the engaging portions 27 in the body 11.

(5) The plurality of sets each including the convex contact point portion 24 and the engaging portions 27 are provided on the busbar 10. According to this configuration, the busbar 10 can be fixed to the body 11 by the plurality of engaging portions 27, which further contributes to preventing the lift of the busbar 10.

(6) The convex contact point portions 24 are arranged at the positions near the tip of the busbar 10. According to this configuration, the lift of the busbar 10 from the tip can be made difficult to occur, which further contributes to preventing the lift of the busbar 10.

(7) The busbar 10 includes the busbar body portion 17 at least partially embedded in the body 11 and the busbar tip portion 18 exposed from the body 11 and shaped by being bent in the direction intersecting the extending direction of the busbar body portion 17. The convex contact point portions 24 and the engaging portions 27 are provided on the busbar tip portion 18. According to this configuration, the busbar 18 can be made difficult to lift from the body 11.

(8) The body 11 includes the seat portions 19 for placing the busbar tip portions 18. The busbar tip portion 18 is formed to have the same width and depth as the seat portion 19 in the part to be placed on the seat portion 19. According to this configuration, if the busbar tip portion 18 is shaped to be placed on the seat portion 19 of the body 11, there is, for example, a possible situation where the busbar tip portion 18 can only be formed to have the same area as the seat portion 19. However, since the busbar tip portion 18 is provided with the engaging portions 27, the busbar tip portion 18 can be firmly fixed to the seat portion 19 even if the busbar tip portion 18 is limited in size.

(9) The busbar tip portion 18 is in the form of a rectangular plate. In the case of providing a plurality of the convex contact point portions 24, the convex contact point portions 24 are arranged side by side in the longitudinal direction of the busbar tip portion 18. According to this configuration, the convex contact point portions 24 can be arranged in a well-balanced manner at suitable positions on the busbar tip portion 18 in the form of a rectangular plate.

(10) The mating terminal 13 includes the plate-like portion 14 for contacting the busbar 10. According to this configuration, even if the plate-like portion 14 of the mating terminal 13 is brought into contact with the busbar 10, the plate-like portion 14 and the busbar 10 can easily contact each other since a contact destination of the plate-like portion 14 is the convex contact point portions 24.

(11) In the case of providing a plurality of the busbars 10, the busbars 10 are arranged side by side in the plane direction of the connector body 3. According to this configuration, the shape of the connector body 3 can be such a simple shape that the busbars 10 are juxtaposed in the plane direction of the connector body 3.

### OTHER EMBODIMENTS

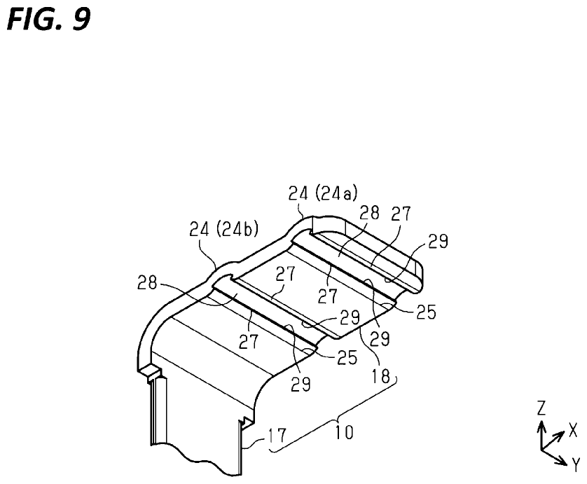

Note that the above embodiment can be modified and carried out as follows. The above embodiment and the following modifications can be carried out in combination without technically contradicting each other.
As shown in FIG. 9, the engaging portions 27 may be formed in the entire region in the width direction on the underside of the busbar 10. In this case, since the engaging portions 27 can be formed to be long, an effect of firmly embedding the engaging portions 27 in the body 11 is enhanced.
The shape of the convex contact point portion 24 is not limited to the semicircular shape in cross-section and may be, for example, changed to another shape such as a triangular shape or trapezoidal shape in cross-section.
The engaging portions 27 may be, for example, formed on the peripheral edge of the recessed portion 25 instead of the recess 28.
The busbar tip portion 18 may be, for example, placed on a flat surface of the body 11 without being limited to placement on the seat portion 19.
The busbar 10 may be in the form of a plate extending straight. In this way, the shape of the busbar 10 may be changed to another shape as appropriate.
The shape of the busbar tip portion 18 is not limited to the rectangular plate shape and may be, for example, a circular shape. Further, the busbar tip portion 18 may be, for example, shaped such that a disk portion is provided on the tip of a rectangular plate.
In the case of providing a plurality of the busbars 10, the connector body 3 may be shaped such that the busbars 10 are arranged side by side in a height direction in the connector body 3.
Only one busbar 10 may be provided in the connector body 3.
There is no limitation to the plurality of sets of the convex contact point portions 24 and the engaging portions 27 and, for example, only one set may be provided.
There is no limitation to the convex contact point portions 24 and the engaging portions 27 formed simultaneously, and these may be formed in separate steps.
The plan view shape of the recess 28 is not limited to the long hole shape and may be, for example, changed to another shape such as a circular shape or square shape.
The engaging portion 27 may be formed on the entire peripheral edge of the recess 28.
A plurality of the recesses 28 may be, for example, formed side by side in the width direction of the busbar 10.
The mating terminal 13 is not limited to the structure for bringing the mating terminal 13 into contact with the busbar 10 by the biasing force of the biasing portion 15 and may be, for example, structured to be fixed to the busbar 10 by a fastening member such as a bolt.
Although the present disclosure has been described with reference to the embodiment, it is understood as not being limited to the embodiment and structures. The present disclosure encompasses various modifications and modifications within the range of equivalents. In addition, various combinations and forms, as well as other combinations and forms including only one element or more or less elements than that are also within the scope and sprit of the present disclosure.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising a connector body, a busbar to be electrically connected to a mating terminal being integrally formed with resin by molding in the connector body,
the busbar including:
a convex contact point portion formed by convexly bending a part of the busbar as a contact point with the mating terminal; and
an engaging portion formed on an inner surface of the convex contact point portion in such a manner as to be embedded in a body of the connector body.

2. The connector of claim 1, wherein the engaging portion is formed on the busbar simultaneously with the convex contact point portion when the convex contact point portion is formed on the busbar.

3. The connector of claim 1, wherein:
the convex contact point portion includes a recess formed by thinning a part of the busbar on the inner surface, and
the engaging portion is formed on at least a part of a peripheral edge of the recess.

4. The connector of claim 3, wherein:
the recess is formed into a shape having an opening in the form of a long hole,
the recess is provided with a pair of width direction opening edges extending in a width direction of the busbar and arranged to face each other and a pair of width cross direction opening edges extending in a direction intersecting the width direction opening edges and arranged to face each other, and
the engaging portions are formed at least on the width direction opening edges.

5. The connector of claim 1, wherein a plurality of sets each including the convex contact point portion and the engaging portion are provided on the busbar.

6. The connector of claim 1, wherein the convex contact point portion is arranged at a position near a tip of the busbar.

7. The connector of claim 1, wherein:
the busbar includes a busbar body portion at least partially embedded in the body and a busbar tip portion exposed from the body and shaped by being bent in a direction intersecting an extending direction of the busbar body portion, and
the convex contact point portion and the engaging portion are provided on the busbar tip portion.

8. The connector of claim 7, wherein:
the body includes a seat portion for placing the busbar tip portion, and
the busbar tip portion is formed to have the same width and depth as the seat portion in a part to be placed on the seat portion.

9. The connector of claim 7, wherein:
the busbar tip portion is in the form of a rectangular plate, and
the convex contact point portions are arranged side by side in a longitudinal direction of the busbar tip portion in the case of providing a plurality of the convex contact point portions.

10. The connector of claim 1, wherein the mating terminal includes a plate-like portion for contacting the busbar.

11. The connector of claim 1, wherein the busbars are arranged side by side in a plane direction of the connector body in the case of providing a plurality of the busbars.
